(19) United States
(12) Patent Application Publication
(10) Pub. No.: US 2004/0011392 A1
(43) Pub. Date: Jan. 22, 2004

(54) Crutch with hands-free attachment

(76) Inventors: John H. Maulden, Fort Worth, TX (US); Cathy H. Hudson, Houston, TX (US)

Correspondence Address: James E. Bradley, Bracewell & Patterson, L.L.P., P.O. Box 61389, Houston, TX, 77208, US

(21) Appl. No.: 10/465,692

(22) Filed: Jun. 19, 2003

Related U.S. Application Data
(60) Provisional application No. 60/397,648, filed on Jul. 22, 2002.

(51) Int. Cl. A61H 3/02

(52) U.S. Cl. 135/68

(57) ABSTRACT

A crutch has a hands-free attachment. The crutch has a pair of generally spaced apart vertical members having an upper end and a brace connected to the upper end of the each of the pair of vertical members which provides upper end structural support and an interface with the underarm of a user. The crutch also has a handgrip connected to and positioned between the vertical members which provides for an interface with a hand of the user. The crutch further includes a peg mounted to the vertical members between the handgrip and the brace and extending laterally therefrom, for engagement by a forearm of the user.

### RELATED APPLICATIONS

This application claims the benefit of provisional application serial No. 60/397,648, filed on Jul. 22, 2002, which is hereby incorporated by reference in its entirety.

### BACKGROUND OF THE INVENTION

1. Field of the Invention

The invention relates to the field of support devices for the infirm or disabled persons and more particularly relates to improvements in walking assistance type crutches.

2. Brief Description of the Related Art

Crutches have long been used as an ambulatory aid to assist injured or otherwise disabled persons in standing or walking. In most cases, a pair of crutches are used temporarily to provide mobility to the user. There are two major types of crutch design, the underarm crutch and the forearm crutch.

The average person is basically familiar with the more common underarm crutch. The typical configuration of the underarm crutch takes the form of a bow-type tubular crutch structure which consists of a pair of bowed tubes, side-by-side, bridged at their upper extremities by an under arm support and at the midsection by a handle grip. Such crutches have typically incorporated a “Y” frame design. Such a frame has two members that converge near the bottom and attach to a central leg member. The central leg member includes a rounded tip which makes contact with the ground. The two frame members are spread apart at the top to support an underarm brace. Horizontally opposing sets of holes in the frame members permit a handgrip to be attached between the frame members by a bolt and wingnut. A handgrip is provided which is vertically adjustable in order to compensate for user's arm length. Similarly, the central leg member is vertically adjustable to compensate for a user's height so as to better fit beneath the arm of the user. The underarm crutch is more stable than the forearm crutch. When the user grips the hand rest near the middle of the crutch and flexes his elbow, the underarm rest seats underneath his arm. To obtain locomotion using the underarm crutch, the user grips the handgrips and shifts weight either to an opposing crutch or the user's legs and raises the crutch or crutches, moving the central leg member in the desired direction. On the other hand, the forearm crutch allows the user to flex at the elbow to manipulate the crutch. The forearm crutch, however, is less stable than the underarm crutch, increasing the metabolic energy requirements of locomotion. Also, since the crutch does not extend above the elbow, the user cannot stabilize the crutch against his body as well as with the underarm crutch.

As stated, the use of the pair of crutches typically requires both hands, simultaneously. However, in order to get through activities of daily living, or to continue performing their jobs, users frequently need to carry a newspaper, documents, notepads, briefcases, beverages, and the like. Crutch users have considerable difficulty carrying such articles by hand while simultaneously supporting themselves on a pair of crutches because the user must grasp and lean on each handgrip in order to manipulate the crutch. While temporarily confined to crutches, users need a method of transporting accessories. Accordingly, there is a need for a crutch which allows for hands-free operation.

Many attempts have been made in the past to improve conventional underarm crutches. Some have attempted to solve this problem by adding accessory carriers, and the like, to the individual crutch structural members. This methodology has not been successful because the user still is unable to perform locomotion while holding the desired articles within the user's hands. Also, the articles must be stowed in the accessory carrier prior to travel. Additionally, some users do not have proper function or dexterity in their hands to properly utilize the handgrips due to illnesses such as arthritis, or the like, nor do they have the strength or dexterity to use an alternative type of crutch such as the forearm crutch. Thus, the prior art has been unable to satisfy the users desire to have utilization of the users hands while simultaneously using a crutch. Accordingly, the need still exists for a crutch which allows hands-free operation.

### SUMMARY OF THE INVENTION

In view of the foregoing, an embodiment of the present invention advantageously provides a crutch including a pair of generally spaced apart vertical members having an upper end, a brace connected to the upper end of the each of the pair of vertical members which provides upper end structural support and an interface with the underarm of a user, and a handgrip connected to and positioned between the vertical members which provides for an interface with a hand of the user. The crutch also includes a peg mounted to the vertical members between the handgrip and the brace and extending laterally from a plane containing the vertical members, for engagement by a forearm of the user. An embodiment of the present invention also includes an attachment plate assembly to which the peg is mounted, connected to and positioned between the vertical members. The positioning of the attachment plate assembly is selected to allow the user to grasp the peg. In an embodiment, a fastener affixes the peg to the attachment plate assembly.

In another embodiment, the peg further includes a substantially central bore located therein for receiving the fastener, and an endcap including a channel positioned to receive an end of the fastener contact an outer end of the peg to compressingly affix the peg to the attachment plate assembly. Preferably the channel of the endcap and an end of the fastener threadingly engage each other to compressingly affix the peg to the attachment plate assembly.

In an embodiment, the crutch further includes a first and a second attachment plate, each plate having a pair of vertical channels. In this embodiment, when the two plates are placed together the pair of channels combine to form a recess which defines a clamp for receiving the vertical members. The peg is secured to at least one of the attachment plates.

In another embodiment, the pair of vertical members further include a plurality of spaced apart horizontal bores for receiving a plurality of fasteners. In this embodiment, the crutch further includes an attachment plate assembly having a plurality of horizontal bores of the vertical members for receiving the plurality of fasteners to position the attachment plate assembly between the pair of vertical members by the plurality of fasteners. The peg is secured to the attachment plate assembly.

Advantageously, an embodiment of the present invention also provides a method of using a crutch having a pair of generally spaced apart vertical members having an upper end, a brace to the upper end of the each of the pair of vertical members, and a handgrip between the vertical members. The method includes mounting a peg to the vertical members between the handgrip and the brace, the peg extending laterally therefrom, to use the crutch hands-free. The method also includes placing the brace under a user's underarm and bending the arms to grasp the pegs between forearm and upper arm of the user, swinging the lower ends of the crutches forward while hands of the user are disengaged from the handgrip. The user then uses the crutches conventionally, disengaging the user's arms from the pegs and gripping the handgrips. In another embodiment, the method further includes alternately lifting the user's feet while applying weight on the braces, then contacting the ground with the user's feet while swinging the corner ends of the crutch forward with the pegs.

Advantageously, an embodiment of the present invention also provides a crutch hands-free attachment kit for allowing a user to perform hands-free locomotion using a conventional underarm crutch. The typical crutch includes a pair of generally spaced apart vertical members having an upper end, a brace connected to the upper end of the each of the pair of vertical members, and a handgrip connected to and positioned between the vertical members. The kit includes an attachment plate assembly adapted to be connected to and positioned between the vertical members of the crutch and a peg mounted to and extending normally from the attachment assembly, for engagement by a forearm of the user. In an embodiment, the kit also includes a fastener that affixes the peg to the attachment plate assembly.

In another embodiment, the peg further includes a substantially central bore located therein adapted for receiving the fastener, and an endcap including a channel that receives an end of the fastener to compressingly affix the peg to the attachment plate assembly. In that embodiment, the channel of the endcap and an end of the fastener to threadingly engage each other to compressingly affix the peg to the attachment plate assembly.

In another embodiment, the attachment plate assembly further includes a first and a second attachment plate, each plate having a pair of vertical channels whereby when the first and second attachment plates are combined, the pair of channels combine to form a recess which defines a clamp adapted to receive the vertical members.

In another embodiment, the kit further includes a fastener extending through the peg into engagement with the first attachment plate. In this embodiment, the peg has an inner end that abuts the second attachment plate, so that tightening the fastener connects the peg to the second attachment plate and draws the first and second attachment plates closer together to clamp them to the crutch.

### BRIEF DESCRIPTION OF THE DRAWINGS

So that the manner in which the features, advantages and objects of the invention, as well as others which will become apparent, are attained and can be understood in more detail, a more particular description of the invention briefly summarized above may be had by reference to the embodiment thereof which is illustrated in the appended drawings, which drawings form a part of this specification. It is to be noted, however, that the drawings illustrate only a preferred embodiment of the invention and is therefore not to be considered limiting of its scope as the invention may admit to other equally effective embodiments.

FIG. 1 is a perspective view showing a user during hands-free use of a pair of crutches having a hands-free attachment according to an embodiment of the present invention.

FIG. 2 is a sectional view of the distal end of the crutch hands-free attachment according to an embodiment of the present invention.

FIG. 3 is a side sectional view of the crutch hands-free attachment according to an embodiment of the present invention.

### DETAILED DESCRIPTION OF THE PREFERRED EMBODIMENT

The present invention will now be described more fully hereinafter with reference to the accompanying drawings which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout, and the prime notation, if used, indicates similar elements in alternative embodiments.

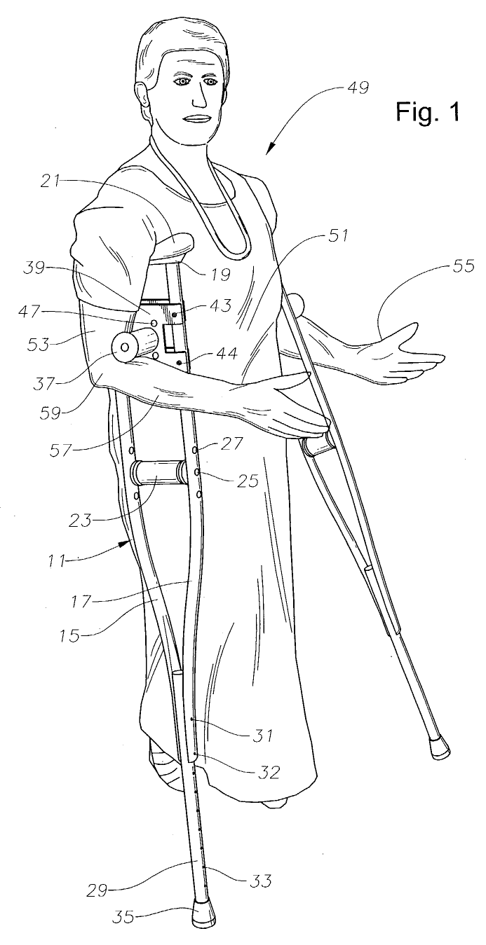

FIGS. 1-3 illustrate the preferred embodiment of crutches 11 having hands-free attachments 13. Referring to FIG. 1, crutches 11 are typically used in pairs, but a single crutch 11 may be used. Each crutch 11 is formed as a frame and is preferably formed from rigid materials, such as wood, metal, or plastic.

Referring to FIG. 1, an embodiment of the present invention advantageously provides a crutch 11 which typically includes a pair of vertical members 15, 17, connected at various points along the height of the each crutch 11. Members 15, 17, are generally spaced apart, with the lower ends of members 15, 17, curving toward each other, narrowing the space between members 15, 17. Some variations differ than that stated above but are not outside the scope of the present invention. A brace 19 connects the upper end of the each of the pair of vertical members 15, 17. The brace 19 provides upper end structural support to the crutch 11 and an interface with the underarm of a user. A pad 21 is formed from a resilient material and covers brace 19 for cushioning the force of brace 19 on the skin under the arm of the user.

A handgrip 23 is connected to and positioned between the vertical members 15, 17, typically with fastener 25, but may be connected by any method as known by those skilled in the art. The handgrip 23 provides for an interface with a hand 55 of the user. The handgrip 23 is generally adjustable, having one of several pairs of corresponding holes 27, similar to those shown in FIG. 1, or may be attached with a ring type clamp, or the like (not shown). Leg 29 is typically secured between the lower ends of members 15, 17, with fasteners 31, 32, and a plurality of holes 33 are provided to allow the user to adjust the height of brace 19 relative to a support surface (not shown). An elastomer foot 35 is located on the lower end of leg 29 for providing increased resistance to slipping and for cushioning the force as crutch 11 contacts the support surface. During use, the weight of the user is transferred from brace 19 or handgrip 23, through members 15, 17, into leg 29, then through foot 35 into the support surface.

In another embodiment, the pair of vertical members 15, 17, further include a plurality of spaced apart horizontal bores (not shown) for receiving fasteners, 43, 44 (FIG. 1). In this embodiment, the attachment plate assembly 39 also includes horizontal bores or recesses (not shown) spaced apart to match the spacing of the horizontal bores (not shown) of the vertical members 15, 17, for receiving the fasteners 43, 44. The fasteners 43, 44, are received by the horizontal bores (not shown) in the vertical members 15, 17, and in the attachment plate assembly 39 in order to affix the attachment plate assembly 39 to the vertical members 15, 17.

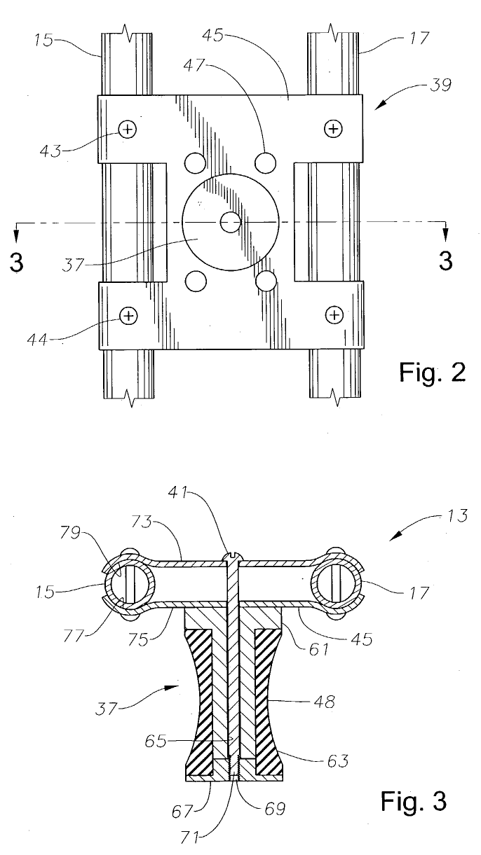

Although fasteners 43, 44, are shown parallel to a plane perpendicular to a longitudinal axis of peg 37, fasteners 43, 44, may be positioned parallel to the longitudinal axis of peg 37 (FIG. 2). For example, in the embodiment where attachment plate assembly includes a first and second attachment plate 73, 75, (FIG. 3), one or both of the pair of attachment plates 73, 75, may include horizontal bores (not shown) spaced to match the spacing of the horizontal bores (not shown) of the vertical members 15, 17, for receiving the plate fasteners 43, 44. The fasteners 43, 44 may then provide either the primary attachment means for one or both of the pair of attachment plates 73, 75, or a secondary structural support for connecting to vertical members 15, 17.

Referring to FIGS. 1-3, hands-free attachment 13 includes a peg 37 mounted or connected to the vertical members 15, 17, between the handgrip 23 and the brace 19 and extends laterally therefrom, for engagement by a forearm 57 or crook of the arm of the user. In an embodiment of the present invention, the hands-free attachment 13 also includes an attachment plate assembly 39 to which the peg 37 is mounted and which is connected to and positioned between the vertical members 15, 17, above handgrip 23. The positioning of the attachment plate assembly 39 is selected to allow the user to more easily engage the peg 37. Outer surface 45 of attachment plate assembly 39 is preferably parallel to a plane bisecting members 15, 17, and peg 37 is attached to attachment plate assembly 39 so that an axis of peg 37 is generally normal to outer surface 45.

In the embodiment of FIG. 1, attachment plate assembly 39 includes a plurality of bores or holes 47 which allow the user to attach peg 37 in a desired location on the attachment plate assembly 39. Various fastening means as known by those skilled in the art, may be employed to affix the peg 37 to the attachment plate assembly 39. For example, the peg 37 may be attached by a screw protruding either through or out of the attachment plate assembly 39 or the peg 37 may be glued to the attachment plate 39 or an intermediate structure therebetween. The preferred structure will be discussed below.

Peg 37 is preferably formed of a rigid member 61, preferably wood, plastic or aluminum. In this embodiment, peg 37 has a cover 63 formed from resilient material such as that used on handgrip 23. This resilient material is typically rubber or a rubber compound. Cover 63 preferably has a narrowed central region 48 for receiving the crook of the arm of a user, as described below.

Referring to FIG. 3, in another embodiment, the peg 37 further includes a substantially central bore 65 located therein for receiving fastener 41, and an endcap 67 including a channel 69 positioned to receive an end 71 of the fastener 41 to compressingly affix the peg 37 to the attachment plate assembly 39. Preferably the channel 69 of the endcap 67 and an end 71 of the fastener 41 are threaded and thus may threadingly engage to compressingly affix the peg 37 to the attachment plate assembly 39. In an alternative embodiment, fastener 41 may directly threadingly engage peg 37 within central bore 65. In another embodiment, a nut (not shown) may be used in place of endcap 67. In another embodiment, peg 37 includes a recess in place of central bore 65 whereby at least one fastener 41 may be used to affix peg 37 to attachment plate assembly 39.

In an embodiment, the attachment plate assembly 39 includes a first and second attachment plate 73, 75, each plate having a pair of vertical channels 77, 79, respectively. In this embodiment, when the two plates 73, 75, are placed together the pair of channels 77, 79, combine to form a recess which defines a clamp for receiving the vertical members 15, 17. In the preferred embodiment, the clamping effect of tightening fastener 41 to peg 37 compresses plates 73, 75, to engage vertical members 15, 17 to hold attachment plate assembly 39 in a fixed position on crutch 11. Additional support to hold attachment plate assembly 39 in place may be provided by various other methods as known by those skilled in the art including adding an additional fastener (not shown) to or through one or both of channels 77, 79.

Advantageously, an embodiment of the present invention also provides a method of using a crutch 11 to provide walking assistance including the steps of providing a pair of generally spaced apart vertical members 15, 17, having an upper end. The method also includes the steps of connecting a brace 19 to the upper end of the each of the pair of vertical members 15, 17, which provides upper end structural support and an interface with the underarm of a user. The method further includes connecting a handgrip 23 to and positioning the handgrip 23 between the vertical members 15, 17, which provides for an interface with a hand of the user. Peg 37 is mounted to the vertical members 15, 17, in a position vertically between the handgrip 23 and the brace 19 so as the peg 37 extends laterally therefrom, for engagement by a forearm of the user.

In another embodiment, the mounting is accomplished by connecting the peg 37 to an attachment plate assembly 39 and connecting the attachment plate assembly 39 to and positioning it between the vertical members 15, 17. The position is preferably selected by the user to allow the user to more easily grasp the peg 37. In an embodiment, a fastener 41 is used to affix the peg 37 to the attachment plate assembly 39.

Advantageously, an embodiment of the present invention also provides a crutch hands-free attachment kit for allowing a user to perform hands-free locomotion using a conventional underarm crutch. The kit may be added to an existing crutch 11 by the manufacturer or added by the end-user. The kit includes a container (not shown) and attachment plate assembly 39 adapted to be connected to and positioned between the vertical members 15, 17, of the crutch 11 and peg 37 mounted to and extending normally from the attachment assembly 39, for engagement by a forearm of the user. In an embodiment, the kit also includes fastener 41 that affixes the peg 37 to the attachment plate assembly 39. The peg 37 preferably includes a central rigid member 61 and an outer cover 63 formed of a resilient material substantially surrounding the outer surface of the rigid member 61.

In an embodiment, the attachment plate assembly 39 further includes a first and second attachment plate 73, 75, each plate having a pair of vertical channels 77, 79, respectively, whereby when the first and second attachment plates 73, 75, are combined, the pair of channels 77, 79, combine to form a recess which defines a clamp adapted to receive the vertical members 15, 17. In an embodiment, a fastener 41 extends through the peg 37 into engagement with the first attachment plate 73, the peg 37 having an inner end that abuts the second attachment plate 75, so that tightening the fastener 41 connects the peg 37 to the second attachment plate 75 and draws the first and second attachment plates 73, 75, closer together to clamp them to the crutch 11.

In an embodiment, the kit further includes plate fasteners 43, 44. The pair of vertical members 15, 17, also include spaced apart horizontal bores (not shown) for receiving the plate fasteners 43, 44. The attachment plate assembly 39, includes horizontal bores (not shown) spaced to match the spacing of the horizontal bores (not shown) of the vertical members 15, 17, for receiving the plate fasteners 43, 44. In this configuration, the attachment plate assembly 39 is adapted to be attached to and positioned about the vertical members 15, 17 by the plate fasteners 43, 44.

Referring to FIG. 1, for normal use of crutches 11, a user 49 adjusts handgrip 23 and leg 29 to desired positions on members 15, 17. User 49 then places the upper end of each crutch between torso 51 and the inner surface of the upper arm 53, brace 19 and pad 21 being positioned near the underarm of user 49. Each hand 55 grasps a corresponding handgrip 23 for levering crutch to move leg 29 in a desired direction, crutches 11 typically rotating within a generally vertical plane and about an axis near pad 21. To move leg 29, user 49 shifts weight off of pad 21 and handgrip 23 and lifts crutch 11 to allow leg 29 to move to the desired position, lifting and rotational forces being applied by user 49 to crutch 11 through handgrip 23. Peg 37 is positioned so that it does not interfere with normal use of crutches 11.

Hands-free attachments 13 advantageously allows user 49 to use crutches 11 without the use of hands 55. Crutches 11 remain in the same position as during normal use, with braces 19 under the user's underarm, but hands 55 release handgrips 23 and lower arms 57 are rotated forward at elbows 59 bending the arms to grasp the pegs 37 between the forearm 57 and upper arm 53. This positions hands 55 in front of crutches 11, where hands 55 can be used to carry items or perform other tasks. Peg 37 is grasped by the crook of the arm, which is the inner surface of each elbow 59. The lower end of upper arm 53 and the upper end of lower arm 57 close around grip 37. To rotate crutches 11 for moving legs 29, the user removes weight from crutch 11, and then applies lifting and rotational forces to grip peg 37, these forces performing the same functions as the forces applied to handgrip 23 during normal use, swinging the lower ends 29 of the crutches 11 forward. The user 49 may alternatively lift the user's feet while applying weight on the braces 19, then contact the ground with the user's feet while swinging the lower end 29 of the crutch 11 forward with the peg 37.

The invention has several advantages. The attachment allows for hands-free use of crutches, allowing a user to carry items with the user's hands. Crutches with the hands-free attachment can be used by those without hands or by those with hands that are bandaged or otherwise not able to grip handgrips of typical crutches. The hands-free attachment is an inexpensive and simple to install addition that can be retrofitted to existing crutches, installed as a separate component in new crutches, or formed as an integral part of new crutches. The attachment provides for nearly universal use through adjustment of the position of the peg.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification. For example, the peg and plate can be formed as one piece, or the frame members, brace and hands-free attachment can be formed as one piece. Also, the peg fastener may be implemented 180 degrees to the direction shown in FIG. 3. Additionally, where such items as the plate fasteners are shown as a pair, and the peg fastener is shown as a single bolt type fastener, various numbers of these fasteners may be used and the fasteners themselves may be implemented by various fastening methodologies other than screws or bolts as shown in the figures.

What is claimed

1. A crutch comprising:
a pair of generally spaced apart vertical members having an upper end;
a brace connected to the upper end of the each of the pair of vertical members which provides upper end structural support and an interface with the underarm of a user;
a handgrip connected to and positioned between the vertical members which provides for an interface with a hand of the user; and
a peg mounted to the vertical members between the handgrip and the brace and extending laterally from a plane containing the vertical members for engagement by a forearm of the user.

2. The crutch as defined in claim 1, further comprising an attachment plate assembly to which the peg is mounted, the attachment plate assembly being connected between the vertical members above the handgrip.

3. The crutch as defined in claim 2, further comprising a fastener affixing the peg to the attachment plate assembly.

4. The crutch as defined in claim 2, further comprising a fastener and wherein the peg further includes a substantially central bore located therein for receiving the fastener, and an endcap including a channel positioned to receive an end of the fastener, the endcap contacting an outer end of the peg to compressingly affix the peg to the attachment plate assembly.

5. The crutch as defined in claim 4, wherein the channel of the endcap and an end of the fastener threadingly engage each other to compressingly affix the peg to the attachment plate assembly.

6. The crutch as defined in claim 1, wherein the peg further comprises a central rigid member and an outer cover formed of a resilient material substantially surrounding an outer surface of the rigid member.

7. The crutch as defined in claim 1, wherein further comprising:
a first and a second attachment plate, each plate having a pair of vertical channels, whereby the pair of channels combine to form a recess which defines a clamp for receiving the vertical members; and
wherein the peg is secured to at least one of the attachment plates.

8. The crutch as defined in claim 1, wherein the pair of vertical members further include a plurality of spaced apart horizontal bores for receiving a plurality of fasteners, and wherein the crutch further comprises:
an attachment plate assembly having a plurality of horizontal bores spaced to match the spacing of the plurality of horizontal bores of the pair of vertical members for receiving the plurality of fasteners to position between the attachment plate assembly between the pair of vertical members by the plurality of fasteners; and wherein
the peg is secured to the attachment plate assembly.

9. A method of using a crutch having: a pair of generally spaced apart vertical members having an upper end, a brace to the upper end of the each of the pair of vertical members; and a handgrip between the vertical members, the method comprising;
(a) mounting a peg to the vertical members between the handgrip and the brace, the peg extending laterally therefrom, then, to use the crutches hands free;
(b) placing the braces under a user's underarms;
(c) bending the arms to grasp the pegs between forearm and upper arm of the user and swinging the lower ends of the crutches forward while the hands of the user are disengaged from the handgrip; and
(d) then, to use the crutches conventionally, disengaging the user's arms from the pegs and gripping the handgrips.

10. The method as defined in claim 9, where step (d) further comprises alternately lifting the user's feet while applying weight on the braces, then contacting the ground with the user's feet while swinging the comer ends of the crutch forward with the pegs.

11. A crutch hands-free attachment kit for allowing a user to perform hands-free locomotion using a conventional underarm crutch including a pair of generally spaced apart vertical members having an upper end, a brace connected to the upper end of the each of the pair of vertical members, and a handgrip connected to and positioned between the vertical members, the kit comprising:
an attachment plate assembly adapted to be connected to and positioned between the vertical members of the crutch; and
a peg mounted to and extending normally from the attachment assembly, for engagement by a forearm of the user.

12. The kit as defined in claim 11, further comprising a fastener that affixes the peg to the attachment plate assembly.

13. The kit as defined in claim 11, further comprising a fastener and wherein the peg further includes a substantially central bore located therein adapted for receiving the fastener, and an endcap including a channel that receives an end of the fastener to compressingly affix the peg to the attachment plate assembly.

14. The kit as defined in claim 13, wherein the channel of the endcap and an end of the fastener to threadingly engage each other to compressingly affix the peg to the attachment plate assembly.

15. The kit as defined in claim 11, wherein the peg further comprises a central rigid member and an outer cover formed of a resilient material substantially surrounding an outer surface of the rigid member.

16. The kit as defined in claim 11, wherein the attachment plate assembly further comprises a first and second attachment plate, each plate having a pair of vertical channels whereby when the first and second attachment plate are combined, the pair of channels combine to form a recess which defines a clamp adapted to receive the vertical members.

17. The kit as defined in claim 11, further comprising a fastener extending through the peg into engagement with the first attachment plate, the peg having an inner end that abuts the second attachment plate, so that tightening the fastener connects the peg to the second attachment plate and draws the first and second attachment plates closer together to clamp them to the crutch.
